(19) United States
(12) Patent Application Publication
(10) Pub. No.: US 2018/0299731 A1
(43) Pub. Date: Oct. 18, 2018

(54) DIRECT-TYPE BACKLIGHT DEVICE AND LIQUID CRYSTAL DISPLAY DEVICE

(71) Applicant: SHARP KABUSHIKI KAISHA, Sakai City, Osaka (JP)

(72) Inventor: YOUZOU KYOUKANE, Sakai City (JP)

(21) Appl. No.: 15/569,525

(22) PCT Filed: Apr. 21, 2016
(86) PCT No.: PCT/JP2016/062580

§ 371 Date: Oct. 26, 2017

(30) Foreign Application Priority Data
Apr. 28, 2015 (JP) 2015-091821

(51) Int. Cl. G02F 1/1335; G02B 5/02

(52) U.S. Cl. CPC G02F 1/133606; G02F 1/133553; G02B 5/0205

(57) ABSTRACT

The present invention provides a thin direct-type backlight device having a narrow frame. The present invention provides a direct-type backlight device including, sequentially from back to front: a base member; multiple light emitting elements arranged on a surface of the base member; and a diffuser, wherein the diffuser includes multiple projecting portions projecting toward the multiple light emitting elements, and the projecting portions are arranged such that ends thereof are in contact with the base member or a member arranged on the surface of the base member at positions that do not overlap with the multiple light emitting elements in a plan view.

### TECHNICAL FIELD

The present invention relates to direct-type backlight devices and liquid crystal display devices. More specifically, the present invention relates to a direct-type backlight device suitable for use in small and medium-sized, liquid crystal display devices, and a liquid crystal display device including the same.

### BACKGROUND ART

Backlight devices are lighting equipment for use in display devices such as liquid crystal display devices. For example, a backlight device is arranged behind a liquid crystal panel, and light generated by the backlight device is transmitted through the liquid crystal panel and emitted to the viewer side of the display device. There are roughly two types of the backlight device based on the structure: edge light type and direct type.

Examples of the structure of the edge light-type backlight device include one in which a light guide plate is provided underneath an optical sheet group including a diffusion sheet and a prism sheet, and light sources are linearly arranged at one end surface of the light guide plate. Light emitted from the light sources is incident on the light guide plate, and is emitted toward a direction (viewer side) that should be illuminated by the light guide plate.

Examples of the structure of the direct-type backlight device include one in which a diffuser is provided underneath an optical sheet group including a diffuser and a prism sheet, and light sources are arranged immediately below the diffuser. Light emitted from the light sources is emitted in parallel to the main plane of the diffuser toward the viewer side.

The backlight device emits light to the liquid crystal panel, and is thus preferably a surface light source that can emit light from its entire light emission surface facing the liquid crystal panel. When the backlight device includes point light sources such as light emitting diodes (LEDs) or line light sources such as cold cathode fluorescent lamps (CCFLs) for the light source, in order to suppress point-like or linear luminance unevenness and to provide a surface light source, the light guide plate and the optical sheet group are arranged in the case of the edge light-type backlight device, whereas the diffuser, the optical sheets, and the like are arranged in the case of the direct-type backlight device.

The edge light-type backlight device can be easily made thinner and is thus suitably used in small and medium-sized displays. In contrast, the direct-type backlight device is highly flexible as to how the light sources are arranged and can easily have higher luminance. Thus, it is suitably used in relatively large backlight devices.

As an example of the direct-type backlight device, Patent Literature 1 discloses a direct-type LED backlight device including a bottom wall (mounting substrate 2), an optical member group 8 arranged facing an inner surface of the bottom wall with a predetermined distance therebetween, a sidewall 6 that maintains the predetermined distance between the bottom wall and the optical member group 8, and multiple LEDs 1 as the light sources fixed on the inner surface of the bottom wall, wherein the sidewall 6 includes, on its inner side, a projecting portion P projecting toward a central portion of a space formed by the bottom wall, the sidewall 6, and the optical member group 8, and the outermost LED 1 is located such that at least a portion of its emission surface overlaps with the projecting portion P and is thus invisible from the optical member group 8 in a vertical direction. With the above structure, Patent Literature 1 aims to provide a direct-type LED backlight device capable of improving color unevenness (or luminance unevenness if the color unevenness is not an issue) at an end portion of the display region without increasing the drive or its control circuit or changing the external shape of a liquid crystal display device.

### CITATION LIST

### Patent Literature

Patent Literature 1: JP-A 2013-114880

### SUMMARY OF INVENTION

### Technical Problem

Lately, small and medium-sized displays for use in devices such as televisions, notebook computers, tablet devices, and smartphones have been made thinner and provided with narrower frames. An attempt to narrow a frame of an edge light-type backlight device is associated with difficulty in sufficiently diffusing light emitted from light sources, unfortunately resulting in so-called eyeball unevenness in which the luminance is high at or near the light sources. In contrast, in the case of a direct-type backlight device, while it is possible to narrow its frame, a certain distance is necessary to diffuse light from light sources to provide a surface light source. Thus, unfortunately, the thickness is increased to provide a distance (clearance) between the diffuser and the light sources.

In the case of the direct-type backlight device, another member is arranged to support the diffuser, whereby the diffuser and the light sources are kept at a distance. For example, in Patent Literature 1, the sidewall 6 is used to maintain a predetermined distance between the bottom wall on which light sources are fixed and the optical member group 8. However, the presence of another member between the diffuser and the light sources enlarges the frame region of the backlight device and increases its thickness due to the width and thickness of the member itself.

The present invention was made in view of the current situation described above, and aims to provide a thin direct-type backlight device having a narrow frame and a liquid crystal display device including the direct-type backlight device.

### Solution to Problem

In order to achieve a narrower frame, the present inventor focused on a direct-type backlight device whose light sources are not arranged at an end portion. In order to provide a thin direct-type backlight device, the present inventor examined methods for supporting a diffuser without providing another member such as a sidewall. Through a series of examinations with the focus on providing a diffuser with a function to support itself, the present inventor modified the conventional structure in which the diffuser is supported by another member to a structure in which the diffuser supports itself by providing projecting portions to the diffuser, and found that it is possible to provide a thin backlight device having a narrow frame. Thus, the above problems were successfully solved, and the present invention was accomplished.

Specifically, in an aspect of the present invention, there may be provided a direct-type backlight device including, sequentially from back to front: a base member; multiple light emitting elements arranged on a surface of the base member; and a diffuser, wherein the diffuser includes multiple projecting portions projecting toward the multiple light emitting elements, and the projecting portions are arranged such that ends thereof are in contact with the base member or a member arranged on the surface of the base member at positions that do not overlap with the multiple light emitting elements in a plan view.

Further, a thin liquid crystal display device having a narrow frame can be obtained by providing the direct-type backlight device thereto. Specifically, in another aspect of the present invention, there may be provided a liquid crystal display device including a liquid crystal panel and the direct-type backlight device, wherein the direct-type backlight device is arranged behind the liquid crystal panel.

### Advantageous Effects of Invention

The direct-type backlight device of the present invention has a narrow frame because the light sources are not on its lateral side, and can be made thin because the diffuser can be maintained by the projecting portions, without the need of providing another member. The liquid crystal display device of the present invention includes the thin direct-type backlight device having a narrow frame, so that the liquid crystal display device can also be made thin with a narrow frame.

### BRIEF DESCRIPTION OF DRAWINGS

FIG. 1 is a schematic cross-sectional view of an exemplary direct-type backlight device according to Embodiment 1.

FIG. 2 is a schematic plan view of the exemplary direct-type backlight device according to Embodiment 1.

FIG. 3 is a schematic cross-sectional view of another exemplary direct-type backlight device according to Embodiment 1.

FIG. 4 is a schematic cross-sectional view of an exemplary liquid crystal display device including the direct-type backlight device according to Embodiment 1.

FIG. 5 is a schematic cross-sectional view of an exemplary direct-type backlight device according to Embodiment 2.

FIG. 6 is a schematic plan view of the exemplary direct-type backlight device according to Embodiment 2.

### DESCRIPTION OF EMBODIMENTS

Embodiments of the present invention are described below with reference to the drawings. The present invention is not limited to the following embodiments. Features of different embodiments may be suitably combined together or modified within the scope of the present invention.

### Embodiment 1

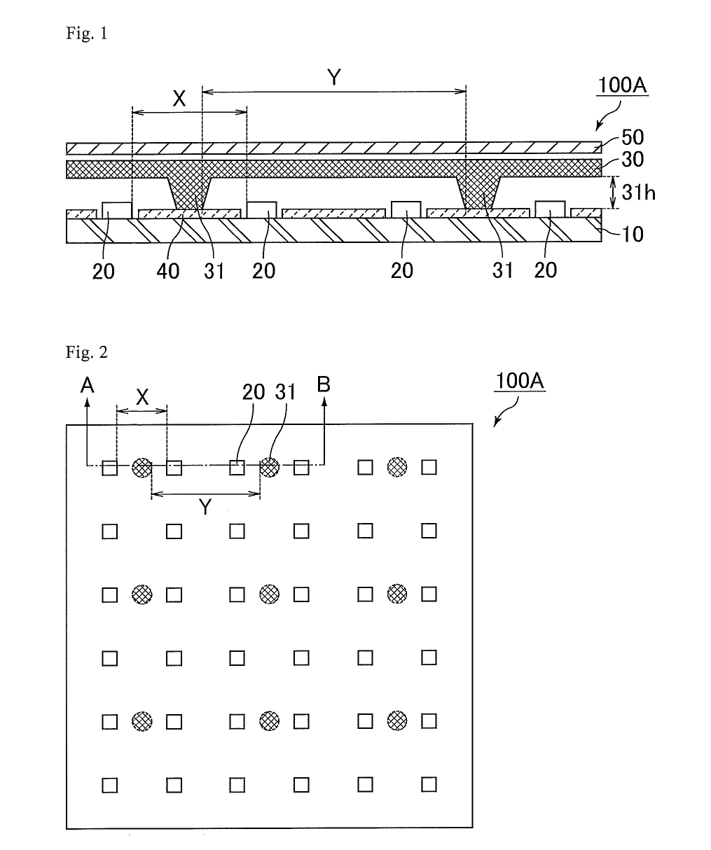

FIG. 1 is a schematic cross-sectional view of an exemplary direct-type backlight device 100A according to Embodiment 1. FIG. 2 is a schematic plan view of the exemplary direct-type backlight device 100A according to Embodiment 1. FIG. 1 is schematic cross-sectional view of FIG. 2 taken along line A-B. As shown in FIG. 1, the direct-type backlight device 100A according to Embodiment 1 includes a base member 10, multiple light emitting elements 20 arranged on a surface of the base member 10, and a diffuser 30 in the stated order, wherein the diffuser 30 includes multiple projecting portions 31 projecting toward the multiple light emitting elements 20, and the projecting portions 31 are arranged such that ends thereof are in contact with the base member 10 or a member 40 arranged on the surface of the base member 10 at positions that do not overlap with the multiple light emitting elements 20 in a plan view. In FIG. 1, the direct-type backlight device 100A has a structure that allows light generated by the multiple light emitting elements 20 to be emitted upward through the diffuser 30. The front of the direct-type backlight device 100A faces the top of FIG. 1, and the back of the direct-type backlight device 100A faces the bottom of FIG. 1.

The backlight device of the present invention is a direct type, so that the multiple light emitting elements 20 are arranged on the surface of the base member 10, preferably at regular intervals in a planar form. Thus, the light emitting elements can be arranged at a wider area and are highly flexible as to how many thereof can be arranged, as compared to those of an edge light type backlight device having light emitting elements arranged at its end portion. Therefore, the direct type backlight device is advantageous for achieving high luminance.

The base member 10 may be any member that can be used as a base for arranging the light emitting elements 20 on the surface thereof. The base member 10 may be a member constituting a back of the direct-type backlight device. Examples of the base member 10 include those formed of materials such as polyethylene terephthalate (PET) and glass epoxy resin. The base member 10 may include a drive circuit and a control circuit to allow the multiple light emitting elements 20 to emit light. When the base member 10 itself reflects light, the member 40 may not be provided on the surface of the base member 10.

The member 40 may be arranged on the surface of the base member 10, and the member 40 arranged on the surface of the base member 10 may be a reflective layer. Any reflective layer that reflects light incident from the diffuser 30 may be used. Examples thereof include thin metal (e.g., silver or aluminium) films and resin (e.g., polyester) films. Owing to the reflective layer, light emitted from the light emitting elements 20 can be reflected to increase the amount of light to be emitted from the light emission surface.

Examples of the light emitting elements 20 include light emitting diodes (LEDs) and cold cathode fluorescent lamps (CCFLs). LEDs are preferred to make the backlight device thin. White light emitting diodes are preferred when the backlight device is used for a liquid crystal display device.

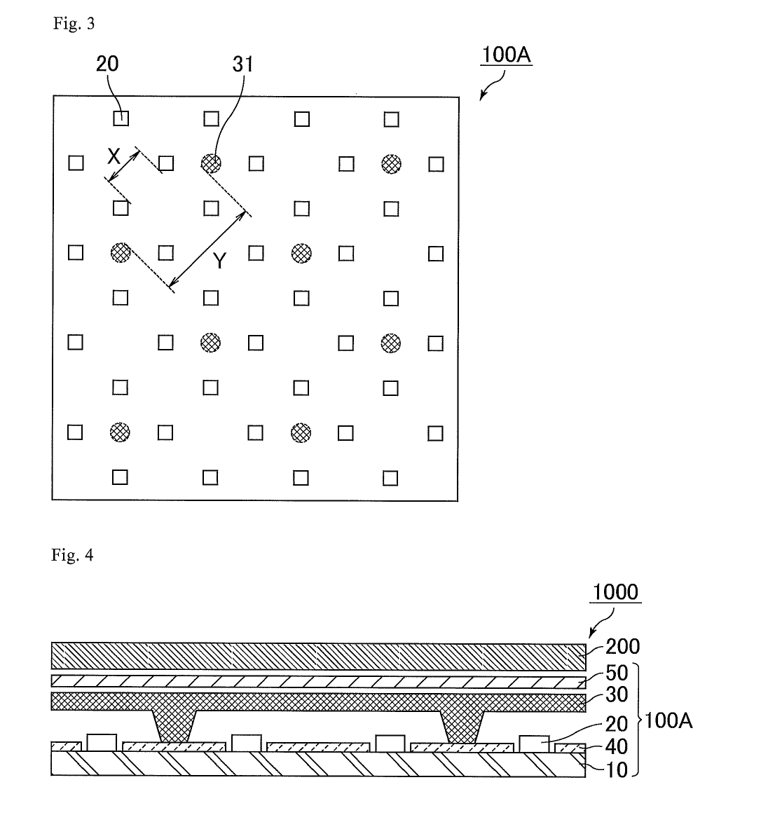

The multiple light emitting elements 20 may be regularly arranged. FIG. 3 is a schematic cross-sectional view of another exemplary direct-type backlight device 100A according to Embodiment 1. As shown in FIG. 2 and FIG. 3, the multiple light emitting elements 20 may be arranged in a matrix.

The multiple light emitting elements 20 may be arranged such that an interval between two adjacent light emitting elements is 5 mm to 20 mm. The phrase “interval between two adjacent light emitting elements” refers to the interval between two light emitting elements that are most closely arranged to each other among the multiple light emitting elements. In FIG. 2 and FIG. 3, the multiple light emitting elements 20 are arranged in a matrix and in such a manner that two adjacent light emitting elements are arranged at an interval X. When the interval between two adjacent light emitting elements is 5 mm to 20 mm, a surface light source having sufficient luminance can be provided. The lower limit of the interval between two adjacent light emitting elements is more preferably 7 mm. The upper limit thereof is more preferably 15 mm. The interval between two adjacent light emitting elements arranged in a row direction may be the same as or different from the interval between two adjacent light emitting elements arranged in a column direction.

The diffuser 30 may be any member having a function to diffuse light incident from the light emitting elements 20 at the back of the direct-type backlight device. Any diffuser commonly used in the field of backlight devices can be used. The presence of the diffuser 30 can reduce the luminance difference between the region where the light emitting elements 20 are arranged at the back of the direct-type backlight device and the region where the light emitting elements 20 are not arranged at the back of the direct-type backlight device, thus providing a direct-type backlight device in which luminance unevenness is reduced in the emission surface. Examples of the diffuser 30 include those formed of materials such as polycarbonate and acrylic resin. The diffuser 30 can be produced by a method such as injection molding process. Projecting portions can be easily formed by the injection molding process.

Ends of the projecting portions 31 are in contact with the base member 10 or the member 40 arranged on the surface of the base member 10, so that the diffuser 30 has a function to support itself and the diffuser 30 does not need to be supported by another member. In addition, the ends of the projecting portions 31 are in contact with the base member 10 or the member 40 at positions that do not overlap with the multiple light emitting elements 20 in a plan view so as to avoid blocking light emitted from the light emitting elements 20.

The projecting portions 31 may have a height 31h of 3 mm to 15 mm. As used herein, the height 31h of the projecting portions 31 refers to the distance from the back surface of the diffuser 30 in the region where no the projecting portions 31 are formed to the side where the ends of the projecting portions 31 are in contact with the base member 10 or the member 40 arranged on the surface of the base member 10. By adjusting the height of the projecting portions 31, a certain distance can be provided between the light emitting elements 20 and the diffuser 30, and light emitted from the light emitting elements 20 can be sufficiently diffused to provide a surface light source. If the height of the projecting portions 31 is less than 3 mm, the distance between the light emitting elements 20 and the diffuser 30 is too short to sufficiently diffuse light emitted from the light emitting elements 20. Thus, the shape of the light emitting elements 20 may be visible when observed from the light emission surface.

The lower limit of the height of the projecting portions 31 is more preferably 5 mm. The upper limit thereof is more preferably 10 mm for providing a thinner backlight device. The projecting portions 31 have a width of about 3 mm, for example.

The multiple projecting portions 31 may be regularly arranged. For example, the projecting portions 31 may be arranged in a matrix, as shown in FIG. 2 and FIG. 3.

The multiple projecting portions 31 may be arranged such that the interval between two adjacent projecting portions is 10 mm to 30 mm. The interval between two adjacent projecting portions 31 is determined by the distance between one point and another point closest thereto in portions (ends of the projecting portions) in contact with the base member 10 or the member 40, i.e., the interval between two projecting portions that are most closely arranged to each other among the multiple projecting portions 31. In FIG. 2 and FIG. 3, the multiple projecting portions 31 are arranged in a matrix, and two adjacent projecting portions are arranged at an interval Y. If the interval between two adjacent projecting portions is less than 10 mm, light emitted from the light emitting elements 20 may be blocked, reducing the luminance of the backlight device. In contrast, when the interval is more than 30 mm, the diffuser may not be sufficiently supported. The lower limit of the interval between two adjacent projecting portions is more preferably 15 mm, and the upper limit thereof is more preferably 25 mm. The interval between two adjacent projecting portions arranged in the row direction may be the same as or different from the interval between two adjacent projecting portions arranged in the column direction.

The direct-type backlight device 100A according to Embodiment 1 may further include an optical sheet 50 in front of the diffuser 30. Owing to the presence of the optical sheet 50, light emitted from the light emitting elements 20 can be diffused and reflected to improve the luminance of the backlight device. Examples of the optical sheet 50 include diffusion sheets and prism sheets. The optical sheet 50 may be used alone, or multiple optical sheets may be stacked.

Any diffusion sheet commonly used in the field of backlight devices can be used. Owing to the presence of the diffusion sheet, light emitted from the multiple light emitting elements 20 and diffused by the diffuser 30 can be further diffused to suppress luminance unevenness. The diffusion sheet can be obtained by any of these methods, for example: mixing materials having different refractive indexes; dispersing transparent spherical materials on a transparent sheet; or forming irregularities on the surface of a transparent sheet.

Any prism sheet commonly used in the field of backlight devices can be used. The prism sheet has a function (light condensation function) that changes the progress direction of light emitted from the multiple light emitting elements 20 and diffused by the diffuser 30 to intensively improve the luminance toward the light emission surface of the backlight device. The prism sheet may have a structure in which structures such as triangular pyramids, quadrangular pyramids, or hemispheres are aligned on a surface thereof. Examples of materials of the prism sheet include resins such as acrylic, styrene, polycarbonate, polyethylene terephthalate, acrylonitrile, epoxy acrylate, and urethane acrylate.

The direct-type backlight device 100A according to Embodiment 1 is arranged behind a liquid crystal panel of a liquid crystal display device. FIG. 4 is a schematic cross-sectional view of an exemplary liquid crystal display device 1000 including the direct-type backlight device 100A according to Embodiment 1. As shown in FIG. 4, the direct-type backlight device 100A may be arranged behind a liquid crystal panel 200. The liquid crystal panel 200 is not particularly limited, and may be one commonly used in the field of liquid crystal display devices. Examples of the structure of the liquid crystal panel 200 include one sequentially including: a color filter substrate including color filters, counter electrodes, and the like; a liquid crystal layer; and a TFT substrate including pixel electrodes, signal lines, thin film transistors, and the like, wherein a polarizing plate is arranged on each of the color filter substrate and the TFT substrate, on the side opposite to the liquid crystal layer.

### Embodiment 2

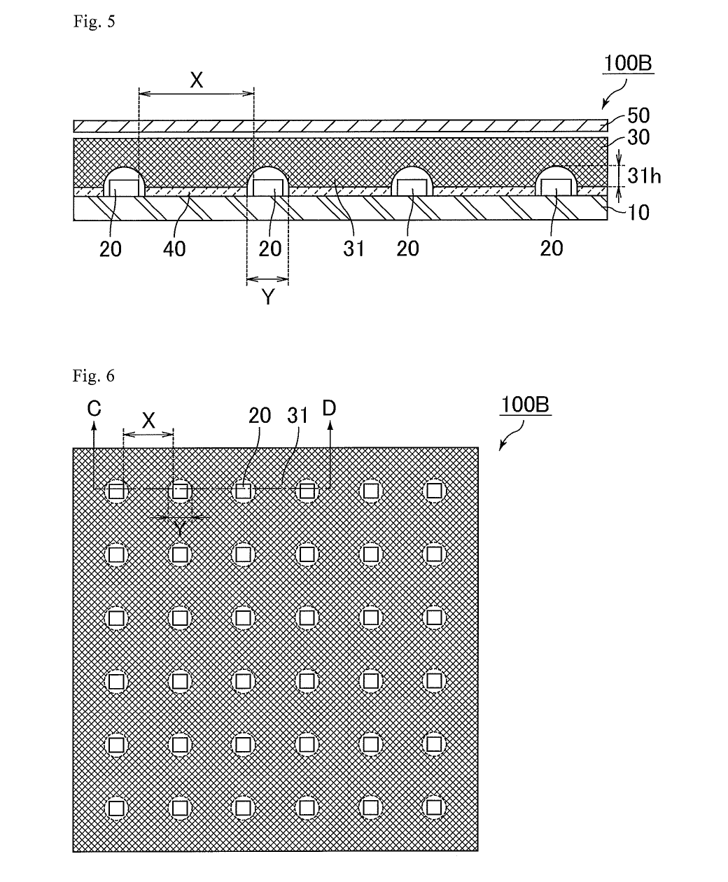

A backlight device of Embodiment 2 is the same as that of Embodiment 1, except that the shape of the projecting portions 31 is different. FIG. 5 is a schematic cross-sectional view of an exemplary direct-type backlight device 100B according to Embodiment 2. FIG. 6 is a schematic plan view of the exemplary direct-type backlight device 100B according to Embodiment 2. FIG. 5 is a schematic cross-sectional view of FIG. 6 taken along line C-D. In Embodiment 2, the contact area between the end of each of the multiple projecting portions 31 and the base member 10 or the member 40 arranged on the surface of the base member 10 is wider than that in Embodiment 1. In addition, as shown in FIG. 5, the ends of the projecting portions 31 may be each arranged between two adjacent light emitting elements 20 so as to form a dome-like space above each light emitting element 20. With the above structure, light emitted from the multiple light emitting elements 20 can be further diffused, and luminance unevenness can be further suppressed.

### [Appendix]

In an aspect of the present invention, there may be provided a direct-type backlight device including, sequentially from back to front: a base member; multiple light emitting elements arranged on a surface of the base member; and a diffuser, wherein the diffuser includes multiple projecting portions projecting toward the multiple light emitting elements, and the projecting portions are arranged such that ends thereof are in contact with the base member or a member arranged on the surface of the base member at positions that do not overlap with the multiple light emitting elements in a plan view.

The projecting portions may have a height of 3 mm to 15 mm.

The multiple light emitting elements may be arranged such that an interval between two adjacent light emitting elements is 5 mm to 20 mm.

The multiple projecting portions may be arranged such that an interval between two adjacent projecting portions is 10 mm to 30 mm.

The member arranged on the surface of the base member may be a reflective layer.

The direct-type backlight device may further include an optical sheet in front of the diffuser.

The light emitting elements may be light emitting diodes.

In another aspect of the present invention, there may be provided a liquid crystal display device including a liquid crystal panel and the direct-type backlight device, wherein the direct-type backlight device is arranged behind the liquid crystal panel.

### REFERENCE SIGNS LIST

10: base member
20: light emitting element
30: diffuser
31: projecting portion
31h: height of projecting portions
40: member arranged on the surface of the base member
50: optical sheet
X: interval between two adjacent light emitting elements
Y: interval between two adjacent projecting portions
100A: direct-type backlight device according to Embodiment 1
100B: direct-type backlight device according to Embodiment 2
200: liquid crystal panel
1000: liquid crystal display device including the direct-type backlight device according to Embodiment 1

1. A direct-type backlight device comprising, sequentially from back to front:
a base member;
multiple light emitting elements arranged on a surface of the base member; and
a diffuser,
wherein the diffuser includes multiple projecting portions projecting toward the multiple light emitting elements, and
the projecting portions are arranged such that ends thereof are in contact with the base member or a member arranged on the surface of the base member at positions that do not overlap with the multiple light emitting elements in a plan view.

2. The direct-type backlight device according to claim 1,
wherein the projecting portions have a height of 3 min to 15 mm.

3. The direct-type backlight device according to claim 1,
wherein the multiple light emitting elements are arranged such that an interval between two adjacent light emitting elements is 5 mm to 20 mm.

4. The direct-type backlight device according to claim 1,
wherein the multiple projecting portions are arranged such that an interval between two adjacent projecting portions is 10 mm to 30 mm.

5. The direct-type backlight device according to claim 1,
wherein the member arranged on the surface of the base member is a reflective layer.

6. The direct-type backlight device according to claim 1, further comprising an optical sheet of the diffuser.

7. The direct-type backlight device according to claim 1,
wherein the light emitting elements are light emitting diodes.

8. A liquid crystal display device comprising:
a liquid crystal panel; and
the direct-type backlight device according to claim 1,
wherein the direct-type backlight device is arranged behind the liquid crystal panel.
